(19) United States
(12) Patent Application Publication
(10) Pub. No.: US 2013/0284518 A1
(43) Pub. Date: Oct. 31, 2013

(54) METHOD OF USING MULTI-COMPONENT FIBERS AS LOST-CIRCULATION MATERIAL

(71) Applicant: 3M INNOVATIVE PROPERTIES COMPANY, ST. PAUL, MN (US)

(72) Inventors: Yong K. Wu, Woodbury, MN (US); Keith A. Rutkowski, Woodbury, MN (US); Clara E. Mata, Lindstrom, MN (US); Ignatius A. Kadoma, Cottage Grove, MN (US); Michael D. Crandall, North Oaks, MN (US)

(73) Assignee: 3M INNOVATIVE PROPERTIES COMPANY, ST. PAUL, MN (US)

(21) Appl. No.: 13/833,807

(22) Filed: Mar. 15, 2013

Related U.S. Application Data
(60) Provisional application No. 61/639,486, filed on Apr. 27, 2012.

(51) Int. Cl. C09K 8/035; E21B 21/00

(52) U.S. Cl. CPC C09K 8/035; E21B 21/003
USPC 175/65

(57) ABSTRACT

A method of forming a subterranean well and a method of reducing lost circulation in a subterranean well while drilling the subterranean well are disclosed. The methods include using multi-component fibers as lost-circulation materials. The multi-component fibers having external surfaces and include at least a first polymeric composition and a second polymeric composition. At least a portion of the external surfaces of the multi-component fibers includes the first polymeric composition, which at least partially adhesively bonds the mud cake formed during the method.

### CROSS-REFERENCE TO RELATED APPLICATION

This application claims priority to U.S. Provisional Application No. 61/639,486, filed Apr. 27, 2012, the disclosure of which is incorporated by reference in its entirety herein.

### BACKGROUND

To produce wells for recovering hydrocarbons from subterranean formations, boreholes are drilled into the formations. Drilling operations typically include the use of a drilling fluid that circulates in the borehole. Drilling fluids have a number of functions such as lubricating the drilling tool and drill pipe that carries the tool, providing a medium for removing formation cuttings from the well to the surface, counterbalancing formation pressure to prevent the inflow to the wellbore of gas, oil, and/or water from permeable or porous formations that may be encountered at various levels as drilling progresses, maintaining hole stability before setting the casing, minimizing formation damage, and holding the drill cuttings in suspension, especially in the event of a shutdown in drilling and interruption of pumping of the drilling mud. The drilling fluid must circulate in the wellbore (down the drill pipe and back up the annulus between the drill pipe and the borehole wall) in order to perform these functions to allow the drilling process to continue.

Fluid loss is common in drilling operations. Drilling fluids are designed to seal porous formations intentionally during drilling by the creation of a mud cake, which results from suction of the fluid onto the permeable surface when the pressure is greater in the well than in the formation. Drilling fluid may contain fluid loss control additives (that is, lost-circulation material) that can help form a thin, low permeability mud cake that can seal openings in formations to reduce the loss of drilling fluids to permeable formations.

However, the loss of fluids (e.g., the whole slurry) to the formation can reach an extent such that no mud cake can be created to secure the surface and create an effective barrier. In extreme situations, for example, when the borehole penetrates a fracture in the formation through which most of the drilling fluid may be lost, the rate of loss may exceed the rate of replacement. Typically, in these situations, drilling operations are stopped until the lost circulation zone is sealed and fluid loss is reduced to an acceptable level. In the worst case, the consequences of this problem can be loss of the well.

A variety of materials (e.g., particles, fibers, and flakes of various materials) have been tried to solve the problem of lost circulation during drilling. Mixtures of particles together with blends of fibers have also been proposed, for example, in U.S. Pat. App. Pub. No. 2010/0298175 (Ghassemzadeh).

### SUMMARY

There is an ongoing need for effective lost-circulation materials that can reduce the loss of drilling fluid into subterranean formations during drilling. The present disclosure describes multi-component fibers useful as lost-circulation materials that can be effective for even severe lost circulation. The multi-component fibers may be useful, for example, as an additive to a drilling fluid to reduce fluid loss during drilling operations and as a component of a composition of a pill treatment when unacceptable levels of fluid loss are observed during drilling operations.

In one aspect, the present disclosure provides a method of forming a subterranean well. The method includes drilling the subterranean well with a drilling mud comprising lost-circulation material and forming a mud cake from at least drill cuttings and the lost-circulation material. The lost-circulation material includes multi-component fibers made from at least a first polymeric composition and a second polymeric composition. At least a portion of the external surfaces of the multi-component fibers includes the first polymeric composition, which at least partially adhesively bonds the mud cake.

In another aspect, the present disclosure provides a method of reducing lost circulation in a subterranean well while drilling the subterranean well. The method includes injecting a composition comprising lost-circulation material into the subterranean well through a drill pipe, forming a mud cake from at least the lost-circulation material, and resuming drilling of the subterranean well after injecting the lost-circulation material. The lost-circulation material includes multi-component fibers made from at least a first polymeric composition and a second polymeric composition. At least a portion of the external surfaces of the multi-component fibers includes the first polymeric composition, which at least partially adhesively bonds the mud cake.

In another aspect, the present disclosure provides use of multi-component fibers as a lost-circulation material while drilling a subterranean well. The multi-component fibers include at least a first polymeric composition and a second polymeric composition. At least a portion of the external surfaces of the multi-component fibers includes the first polymeric composition, which at least partially adhesively bonds a mud cake formed during the drilling.

In the methods disclosed herein, the first polymeric composition can advantageously serve to adhere the multi-component fibers to each other and the other solid components in the mud cake formed while drilling or remedially treating the well for lost circulation during drilling.

In the method of reducing fluid loss disclosed herein, particularly when severe fluid loss is observed, the multi-component fibers disclosed herein advantageously adhere the mud cake together to form a strong, consolidated plug. Furthermore, in some embodiments, as shown in the Examples, below, multi-component fibers can provide unexpectedly thick and self-bonded filter cakes, which may be advantageous when plugging larger openings such as natural fractures, caverns, or vugs that are encountered during drilling.

In this application, terms such as “a”, “an” and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated.

The term “lost-circulation material” (LCM) refers to solid material intentionally introduced into a mud system to reduce and/or prevent the flow of drilling fluid into a formation. “Lost-circulation material” may refer to one material or a combination of materials.

The term “drilling mud” refers to a mixture of fluids and solids, which includes solid suspensions, mixtures and emulsions of liquids, gases and solids, used in operations to drill boreholes into the earth.

The term “aqueous” refers to containing water.

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### BRIEF DESCRIPTION OF THE DRAWINGS

For a more complete understanding of the features and advantages of the present disclosure, reference is now made to the detailed description along with the accompanying figures and in which:

FIGS. 1A-1D are schematic cross-sections of four exemplary multi-component fibers useful as lost-circulation materials in the methods described herein;

FIGS. 2A-2C are schematic cross-sections of three exemplary multi-component fibers useful as lost-circulation materials in the methods described herein;

FIGS. 3A-3E are schematic perspective views of various multi-component fibers useful as lost-circulation materials in the methods described herein; and

FIGS. 4A and 4B are photographs of Mud Cake 2, described in the Example section below, upon formation and while being held and suspended with pliers.

### DETAILED DESCRIPTION

Methods of using multi-component fibers as lost-circulation material include drilling methods, in which the multi-component fibers may be considered to be used as a “prophylactic” to prevent loss of drilling fluid, and as remedy or “pill” treatments when unacceptable levels of fluid loss are observed while drilling. A “pill” is generally understood to be a relatively small quantity of a special blend of drilling mud to accomplish a specific task that is typically not accomplished by the regular drilling mud. In the case of either a drilling method or pill treatment, the multi-component fibers are typically provided dispersed in a fluid.

Drilling fluids and fluids for pill treatment compositions can be aqueous, organic, or a combination of water and organic fluids. Examples of organic fluids useful for practicing the methods disclosed herein include oil-based drilling fluids and so-called synthetic-based drilling fluids.

An aqueous fluid useful for practicing the methods disclosed herein may contain, for example, fresh water, sea water, brine, and mixtures thereof as the continuous phase of the fluid. Useful aqueous fluids may also contain dissolved or dispersed therein viscosity builders (e.g. clays such as bentonite, attapulgite, and sepiolite, and polymers such as cellulosics, xanthan gum, and polyacrylamides); rheological control agents (e.g. dispersants such as polyphosphates, tannins, lignites, and lignosulfonates, or surfactants); weighting agents (e.g., barite, hematite, magnetite, siderite, dolomite, calcite, sodium chloride); hydrate suppressors (e.g. low molecular weight (up to 2000 grams per mole) polyglycols, polyalkyleneoxides, alkyleneoxide copolymers, alkylene glycol ethers, polyalkyleneoxide glycol ethers, carbohydrates, amino acids, amino sulfonates and alcohols having from 1 to 3 carbon atoms as well as salts thereof), and/or other additives.

Organic fluids useful for practicing the methods disclosed herein include oil-based and synthetic-based fluids. Oil-based fluids are typically based on a petroleum oil, e.g. crude oil, diesel oil, biodiesel oil, kerosene, mineral oil, gasoline, naphtha, toluene, or mixtures thereof. Typically, oil-based drilling fluids comprise mineral oil or diesel. Some oil-based drilling fluids are commercially available, for example, from SynOil under the trade designation “SYNDRIL” and from Baker Hughes, Houston, Tex., under the trade designations “CARBO-DRILL” and “CARBO-CORE”. Synthetic-based fluids useful for practicing the methods disclosed herein are sometimes called “pseudo-oil muds” and can be derived from olefins (e.g., linear alpha-olefins or poly alpha-olefins); internal esters and ethers; siloxanes such as polydiorganosiloxanes or organosiloxanes; paraffins such as linear or branched paraffins; and mixtures thereof. Other organic fluids that may be useful for practicing the methods disclosed herein those based on a polyfunctional alcohol or polyfunctional alcoholic derivative (e.g., glycols, polyglycols, polyoxyalkylene, glycol ethers, glycol esters, and mixtures thereof). Useful organic fluids may also contain viscosity builders (e.g. organophilic clays prepared from bentonite, hectorite, or attapulgite and aliphatic amine salts, colloidal asphalt, or polymers such as cellulosics, xanthan gum, gar gum, starches, and polyacrylamides), and rheological control agents and weighting agents such as those described above for aqueous fluids.

Fluids useful for practicing the methods disclosed herein also include combinations of organic fluids and water. For example, the fluid may be an oil-in-water emulsion, which can be up to 25% by weight of an oil dispersed in water in the presence of an emulsifier. Or the fluid may be an “invert emulsion mud”, which may be an oil-based or synthetic-based fluid comprising up to 70% by volume (e.g., in a range from 10% to 70% by volume) of an aqueous phase. Typically, water-in-oil emulsions contain at least one oil-mud emulsifier, which lowers the interfacial tension between oil and water and allows stable emulsions with small drops to be formed. Oil-mud emulsifiers can be calcium fatty-acid soaps made from various fatty acids and lime, or derivatives such as amides, amines, amidoamines and imidazolines made by reactions of fatty acids and various ethanolamine compounds.

Multi-component fibers can generally be made using techniques known in the art for making multi-component (e.g., bi-component) fibers. Such techniques include fiber spinning (see, e.g., U.S. Pat. Nos. 4,406,850 (Hills), 5,458,972 (Hagen), 5,411,693 (Wust), 5,618,479 (Lijten), and 5,989,004 (Cook)). For any of the embodiments of multi-component fibers useful as lost-circulation materials in the methods disclosed herein, the first polymeric composition may be a single polymeric material, a blend of polymeric materials, or a blend of at least one polymer and at least one other additive. Each component of the fibers, including the first polymeric composition, second polymeric composition, and any additional polymers, can be selected to provide desirable performance characteristics.

In some embodiments, multi-component fibers useful for practicing the methods disclosed herein are advantageously non-fusing at temperatures encountered in the well while the subterranean formation is being drilled, which may be in a range from 80° C. to 200° C., for example. In some embodiments, multi-component fibers useful for practicing the methods according to the present disclosure are non-fusing at a temperature of at least 110° C. (in some embodiments, at least 120° C., 125° C., 150° C., or even at least 160° C.). In some embodiments, the multi-component fibers are non-fusing at a temperature of up to 200° C. “Non-fusing” fibers can autogenously bond (i.e., bond without the addition of pressure between fibers) without significant loss of architecture, for example, a core-sheath configuration. The spatial relationship between the first polymeric composition, the second polymeric composition, and optionally any other component of the fiber is generally retained in non-fusing fibers. Many multi-component fibers (e.g., fibers with a core-sheath configuration) undergo so much flow of the sheath composition during autogenous bonding that the core-sheath structure is lost as the sheath composition becomes concentrated at fiber junctions and the core composition is exposed elsewhere. Such multi-component fibers are fusing fibers. The multi-component fibers useful for practicing the present disclosure include a first polymeric composition that makes up at least a portion of the external surface of the fibers and at least partially adhesively bonds the mud cake formed. In non-fusing fibers, heat causes little or no flow of the first polymeric composition so that the adhesive function may extend along external surface of the majority of the multi-component fibers. The loss of structure in fusing fibers may cause this adhesive function to be concentrated at the fiber junctions. Because of this, non-fusing fibers may be more effective at adhesively bonding the mud cake than fusing fibers.

To evaluate whether fibers are non-fusing at a particular temperature, the following test method is used. The fibers are cut to 6 mm lengths, separated, and formed into a flat tuft of interlocking fibers. The larger cross-sectional dimension (e.g., the diameter for a circular cross-section) of twenty of the cut and separated fibers is measured and the median recorded. The tufts of the fibers are heated in a conventional vented convection oven for 5 minutes at the selected test temperature. Twenty individual separate fibers are then selected and their larger cross-section dimension (e.g., diameter) measured and the median recorded. The fibers are designated as “non-fusing” if there is less than 20% change in the measured dimension after the heating.

In some embodiments, the first polymeric composition in the multi-component fibers has a softening temperature of up to 150° C. (in some embodiments, up to 140° C., 130° C., 120° C., 110° C., 100° C., 90° C., 80° C., or 70° C. or in a range from 80° C. to 150° C.). The softening temperature of the first polymeric composition is determined using a stress-controlled rheometer (Model AR2000 manufactured by TA Instruments, New Castle, Del.) according to the following procedure. A sample of the first polymeric composition is placed between two 20 mm parallel plates of the rheometer and pressed to a gap of 2 mm ensuring complete coverage of the plates. A sinusoidal frequency of 1 Hz at 1% strain is then applied over a temperature range of 80° C. to 200° C. The resistance force of the molten resin to the sinusoidal strain is proportional to its modulus which is recorded by a transducer and displayed in graphical format. Using rheometeric software, the modulus is mathematically split into two parts: one part that is in phase with the applied strain (elastic modulus—solid-like behavior), and another part that is out of phase with the applied strain (viscous modulus—liquid-like behavior). The temperature at which the two moduli (elastic and viscous) are identical (the cross-over temperature) is the softening temperature, as it represents the temperature above which the resin begins to behave predominantly like a liquid.

The softening temperature of the first polymeric composition, advantageously, may be above the storage temperature of the multi-component fiber. The desired softening temperature can be achieved by selecting an appropriate single polymeric material or combining two or more polymeric materials. For example, if a polymeric material softens at too high of a temperature it can be decreased by adding a second polymeric material with a lower softening temperature. Also, a polymeric material may be combined with, for example, a plasticizer to achieve the desired softening temperature.

Exemplary polymers that have or may be modified to have a softening temperature up to 150° C. (in some embodiments, up to than 140° C., 130° C., 120° C., 110° C., 100° C., 90° C., 80° C., or 70° C. or in a range from 80° C. to 150° C.) include at least one of (i.e., includes one or more of the following in any combination) ethylene-vinyl alcohol copolymer (e.g., with softening temperature of 156 to 191° C., available from EVAL America, Houston, Tex., under the trade designation “EVAL G176B”), thermoplastic polyurethane (e.g., available from Huntsman, Houston, Tex., under the trade designation “IROGRAN A80 P4699”), polyoxymethylene (e.g., available from Ticona, Florence, Ky., under the trade designation “CELCON FG40U01”), polypropylene (e.g., available from Total, Paris, France, under the trade designation “5571”), polyolefins (e.g., available from ExxonMobil, Houston, Tex., under the trade designation “EXACT 8230”), ethylene-vinyl acetate copolymer (e.g., available from AT Plastics, Edmonton, Alberta, Canada), polyester (e.g., available from Evonik, Parsippany, N.J., under the trade designation “DYNAPOL” or from EMS-Chemie AG, Reichenauerstrasse, Switzerland, under the trade designation “GRILTEX”), polyamides (e.g., available from Arizona Chemical, Jacksonville, Fla., under the trade designation “UNIREZ 2662” or from E.I. du Pont de Nemours, Wilmington, Del., under the trade designation “ELVAMIDE 8660”), phenoxy (e.g., from Inchem, Rock Hill S.C.), vinyls (e.g., polyvinyl chloride form Omnia Plastica, Arsizio, Italy), or acrylics (e.g., from Arkema, Paris, France, under the trade designation “LOTADEREX 8900”). In some embodiments, the first polymeric composition comprises a partially neutralized ethylene-methacrylic acid copolymer commercially available, for example, from E.I. duPont de Nemours & Company, under the trade designations “SURLYN 8660,” “SURLYN 1702,” “SURLYN 1857,” and “SURLYN 9520”) and from Dow Chemical Company, Midland, Mich., under the trade designation “AMPLIFY”. In some embodiments, the first polymeric composition comprises a mixture of a thermoplastic polyurethane obtained from Huntsman under the trade designation “IROGRAN A80 P4699”, a polyoxymethylene obtained from Ticona under the trade designation “CELCON FG40U01”, and a polyolefin obtained from ExxonMobil Chemical under the trade designation “EXACT 8230”. In some embodiments, multi-component fibers useful for the articles according to the present disclosure may comprise in a range from 5 to 85 (in some embodiments, 5 to 40, 40 to 70, or 60 to 70) percent by weight of the first polymeric composition.

In some embodiments of multi-component fibers useful as lost-circulation material in the methods according to the present disclosure, the first polymeric composition has an elastic modulus of less than 3×10⁵ N/m² at a frequency of about 1 Hz at a temperature encountered in the well while the subterranean formation is being drilled, which may be at a temperature of at least 80° C. In these embodiments, typically the first polymeric composition is tacky at the temperature of 80° C. and above. In some embodiments, the first polymeric composition has an elastic modulus of less than 3×10⁵ N/m² at a frequency of about 1 Hz at a temperature of at least 85° C., 90° C., 95° C., or 100° C. For any of these embodiments, the elastic modulus is measured using the method described above for determining softening temperature except the elastic modulus is determined at the selected temperature (e.g., 80° C., 85° C., 90° C., 95° C., or 100° C.). The tackiness of the first polymeric composition at a temperature of at least 80° C. can serve to adhere the multi-component fibers to each other and the other solid components in the mud cake formed while drilling or remedially treating the well for lost circulation during drilling. In some embodiments, the first polymeric composition is designed to be tacky at a specific downhole temperature (e.g., the bottomhole static temperature (BHST). The tacky network may be formed almost instantaneously when the fibers reach their desired position in the formation, providing the possibility of quick control of lost circulation by adhesively bonding the mud cake.

In some embodiments of multi-component fibers useful as lost-circulation materials in the methods disclosed herein, the second polymeric composition has a melting point that is above the temperature encountered in the well while the subterranean formation is being drilled, which may be in a range from 80° C. to 200° C. For example, the melting point may be at least 10, 15, 20, 25, 50, 75, or at least 100° C. above the temperature in the formation. In some embodiments, the melting point of the second polymeric composition is at least 130° C. (in some embodiments, at least 140° C. or 150° C.; in some embodiments, in a range from 160° C. to 220° C.). Exemplary useful second polymeric compositions include at least one of (i.e., includes one or more of the following in any combination) an ethylene-vinyl alcohol copolymer (e.g., available from EVAL America, under the trade designation “EVAL G176B”), polyamide (e.g., available from E.I. du Pont de Nemours under the trade designation “ELVAMIDE” or from BASF North America, Florham Park, N.J., under the trade designation “ULTRAMID”), polyoxymethylene (e.g., available from Ticona under the trade designation “CELCON”), polypropylene (e.g., from Total), polyester (e.g., available from Evonik under the trade designation “DYNAPOL” or from EMS-Chemie AG under the trade designation “GRILTEX”), polyurethane (e.g., available from Huntsman under the trade designation “IROGRAN”), polysulfone, polyimide, polyetheretherketone, or polycarbonate. As described above for the first polymeric compositions, blends of polymers and/or other components can be used to make the second polymeric compositions. For example, a thermoplastic having a melting point of less than 130° C. can be modified by adding a higher-melting thermoplastic polymer. In some embodiments, the second polymeric composition is present in a range from 5 to 40 percent by weight, based on the total weight of the multi-component fiber. The melting temperature is measured by differential scanning calorimetry (DSC). In cases where the second polymeric composition includes more than one polymer, there may be two melting points. In these cases, the melting point of at least 130° C. is the lowest melting point in the second polymeric composition.

Typically, multi-component fibers useful as lost-circulation materials in the methods disclosed herein exhibit at least one of (in some embodiments both) hydrocarbon or hydrolytic resistance. Hydrocarbon and/or hydrolytic resistance can be useful, for example, for the multi-component fibers to be stable in the drilling fluids or pill treatment fluids described above and in the environment encountered in the well being drilled. In some embodiments, when a 5 percent by weight mixture of the plurality of fibers in deionized water is heated at 145° C. for four hours in an autoclave, less than 50% by volume of the plurality of fibers at least one of dissolves or disintegrates, and less than 50% by volume of the first thermoplastic composition and the curable resin at least one of dissolves or disintegrates. Specifically, hydrolytic resistance is determined using the following procedure. One-half gram of fibers is placed into a 12 mL vial containing 10 grams of deionized water. The vial is nitrogen sparged, sealed with a rubber septum and placed in an autoclave at 145° C. for 4 hours. The fibers are then subjected to optical microscopic examination at 100× magnification. They are deemed to have failed the test if either at least 50 percent by volume of the fibers or at least 50 percent by volume of the either the first polymeric composition or second polymeric composition dissolved and/or disintegrated as determined by visual examination under the microscope.

In some embodiments, when a 2 percent weight to volume mixture of the plurality of fibers in kerosene is heated at 145° C. for 24 hours under nitrogen, less than 50% by volume of the plurality of fibers at least one of dissolves or disintegrates, and less than 50% by volume of the first polymeric composition and the second polymeric composition at least one of dissolves or disintegrates. Specifically, hydrocarbon resistance is determined using the following procedure. One-half gram of fibers is placed into 25 mL of kerosene (reagent grade, boiling point 175-320° C., obtained from Sigma-Aldrich, Milwaukee, Wis.), and heated to 145° C. for 24 hours under nitrogen. After 24 hours, the kerosene is cooled, and the fibers are examined using optical microscopy at 100× magnification. They are deemed to have failed the test if either at least 50 percent by volume of the fibers or at least 50 percent by volume of the first polymeric composition or the second polymeric composition dissolved and/or disintegrated as determined by visual examination under the microscope.

In some embodiments, multi-component fibers useful as lost-circulation materials in the methods disclosed herein comprise a curable resin (i.e., a thermosetting resin). The term “curable” as used herein refers to toughening or hardening of a resin by covalent crosslinking, brought about by at least one of chemical additives, electromagnetic radiation (e.g. visible, infrared or ultraviolet), e-beam radiation, or heat. Curable resins include low molecular weight materials, prepolymers, oligomers, and polymers, for example, having a molecular weight in a range from 500 to 5000 grams per mole. Useful curable resins include liquids and solids, for example, having a melting point of at least 50° C. (in some embodiments, at least 60° C., 70° C., or 80° C., in some embodiments, up to 100° C., 110° C., or 120° C.). Exemplary curable resins include at least one of epoxy (e.g., available from Hexion Specialty Chemicals, Houston, Tex., under the trade designations “EPON 2004”, “EPON 828”, or “EPON 1004”), phenolic (e.g., available from Georgia Pacific, Atlanta, Ga.), acrylic, isocyanate (e.g., available from Bayer, Pittsburg, Pa.), phenoxy (e.g., available from Inchem Corp), vinyls, vinyl ethers, or silane (e.g., available from Dow-Corning, Midland, Mich.).

In some embodiments, including any of the embodiments of fibers disclosed herein that include a curable resin, the curable resin is an epoxy resin. Useful epoxy resins generally have, on the average, at least two epoxy groups per molecule. The “average” number of epoxy groups per molecule is defined as the number of epoxy groups in the epoxy-containing material divided by the total number of epoxy molecules present. In some embodiments of fibers or a plurality of fibers disclosed herein, the curable resin is a solid epoxy resin. Suitable epoxy resins include the diglycidyl ether of Bisphenol A (e.g., those available from Hexion Specialty Chemicals under the trade designations “EPON 828”, “EPON 1004”, and “EPON 1001F” and from Dow Chemical Co. under the trade designations “D.E.R. 332” and “D.E.R.

334”), the diglycidyl ether of Bisphenol F (e.g., available from Huntsman Chemical, The Woodlands, Tex., under the trade designation “ARALDITE GY28 1”), cycloaliphatic epoxies (e.g., vinylcyclohexene dioxide, 3,4-epoxycyclohexylmethyl-3,4-epoxycyclohexene carboxylate, 2-(3,4-epoxycylohexyl-5,5-spiro-3,4-epoxy)cyclohexane-metadioxane, bis(3,4-epoxycyclohexyl)adipate, and those available from Dow Chemical Co. under the trade designation “ERL”); epoxidized polybutadiene; silicone resin containing epoxy functionality, flame retardant epoxy resins (e.g., a brominated bisphenol type epoxy resin available, for example, from Dow Chemical Co. under the trade designation “D.E.R. 542”), 1,4-butanediol diglycidyl ether (e.g., available from Huntsman Chemical under the trade designation “ARALDITE RD-2”), diglycidyl ethers of polyoxyalkylene glycols, hydrogenated bisphenol A-epichlorohydrin based epoxy resins (e.g., available from Hexion Specialty Chemicals under the trade designation “EPONEX 1510”), polyglycidyl ether of phenolformaldehyde novolak (e.g., available from Dow Chemical Co. under the trade designation “D.E.N. 431” and “D.E.N. 438”), and glycidyl methacrylate polymers or copolymers.

In some embodiments, including any of the embodiments of fibers disclosed herein that include a curable resin, the multi-component fibers further comprise a curing agent. The term “curing agent” refers to both reactive multifunctional materials that copolymerize with the curable resin (e.g., by addition polymerization) and components that cause the homopolymerization of the curable resin. Some curing agents may both copolymerize with curable resins and cause their homopolymerization, depending on the temperature and other conditions. In some embodiments, the curing agent is present, for example, with the curable resin and/or the first polymeric composition described herein. In some embodiments, the first polymeric composition comprises a curing agent. In some of these embodiments, the first polymeric composition is formulated with, for example, a photoinitiator or catalyst that can cure the curable resin. In some embodiments, the first polymeric composition includes a thermoplastic with functional groups (e.g., acidic or basic functional groups) that can react with or cause the homopolymerization of the curable resin. In some of these embodiments, the first polymeric composition includes a polyurethane. In other of these embodiments, the first polymeric composition includes an ethylene methacrylic acid co-polymer. In any of the embodiments disclosed herein in which the multi-component fiber includes a curable resin, the curable resin may be included as part of the first polymeric composition.

Examples of curing agents (e.g., for epoxy resins) include aromatic amines (e.g., 4,4′ methylene dianiline or an aromatic amine available, for example, from Air Products, Allentown, Pa., under the trade designation “Amicure 101”); aliphatic amines (e.g., diethethylenetriamine, aminoethylpiperazine, or tetraethylenepentamine); modified aliphatic amines (e.g., those available from Air Products under the trade designations “Ancamine XT” or “Ancamine 1768”); cycloaliphatic amines (e.g. those available from Air Products under the trade designations “Ancamine 1618” or “Ancamine 1895”; modified polyether amines (e.g., those available from Huntsman Chemical, The Woodlands, Tex., under the trade designation “Jeffamine”); amidoamines (e.g., those available from Air Products under the trade designations “Ancamide 506”, “Ancamide 2386”, or “Ancamide 2426”); polyamides (e.g., those available from Air Products under the trade designations “Ancamide 220”, “Ancamide 260A”, and “Ancamide 400”); tertiary amines (e.g., those available from Air Products under the trade designations “Ancamine 1110” and “Ancamine K54”); dicyandiamide; substituted ureas (e.g., those available from Air Products under the trade designations “Amicure UR” and “Amicure UR2T”; imidiazoles (e.g., those available from Shikoku Chemicals Corporation, Marugame, Kagawa, Japan under the trade designations “Curezol 2MA-OK” and “Curezol 2PZ”; boron trifluoride monoethylamine; quaternary phosphoneium salts; urethanes, anhydrides (e.g., maleic anhydride and succinic anhydride); carboxylic acids; polysulfides; and mercaptans (e.g., those available from Cognis Corporation, Monheim, Germany, under the trade designation “Capcure WR-6”. In some embodiments, the curing agent is a photoinitiator. Exemplary photoinitiators include aromatic iodonium complex salts (e.g., diaryliodonium hexafluorophosphate, diaryliodonium hexafluoroantimonate, and others described in U.S. Pat. No. 4,256,828 (Smith)); aromatic sulfonium complex salts (e.g., triphenylsulfonium hexafluoroantimonate and others described in U.S. Pat. No. 4,256,828 (Smith)); and metallocene salts (e.g., (115-cyclopentadienyl)η6-xylenes)Fe+ SbF6− and others described in U.S. Pat. No. 5,089,536 (Palazzotto). In some embodiments, the curing agent is selected from the group consisting of amines, urethanes, ureas, amides, carboxylic acids, and imidazole. The curing agent may be present in the fiber (e.g., with the curable resin or with the first polymeric composition) in a range from 0.1 to 40 percent by weight based on the amount of the curable resin, depending on the curing agent selected (e.g., whether it is a catalytic or stoichiometric curing agent). In some embodiments (e.g., embodiments wherein the first polymeric composition includes a polymer that is a curing agent) the weight of the curing agent can exceed the weight of the curable resin. Generally, the curing agent is present in a sufficient amount to cause the curable resin (including any thermoplastic with which it is combined) to reach its gel point (i.e., the time or temperature at which a cross-linked, three-dimensional network begins to form).

Curable resins described herein can be cured using techniques known in the art, including through electromagnetic radiation (e.g. visible, infrared, or ultraviolet), e-beam radiation, heat, or a combination thereof. In some embodiments where a photoinitiator is a curing agent for the curable resin, the fiber may be exposed to light before it is used in the methods disclosed herein and then exposed to heat when the fiber is injected into a subterranean formation. In some embodiments of the multi-component fibers useful as lost-circulation materials in the methods disclosed herein, the onset temperature of the cure of the curable resin is about the same as the softening temperature of the first polymeric composition (e.g., within 20, 15, 10, or 5° C.). In some of these embodiments, the first polymeric composition comprises a curing agent for the curable resin, which may be advantageous, for example, for preventing curing of the resin before the fibers form part of the mud cake in the subterranean formation. In some embodiments, the curable resin, in combination with any curative and/or accelerator, has an cure onset temperature of up to 150° C. (in some embodiments, up to 140° C., 130° C., 120° C., 110° C., or 100° C. or in a range from 80° C. to 150° C.). Without wanting to be bound by theory, it is believed that as the curable resin cures and develops its strength, it will reinforce the tacky network formed between the multi-component fibers and the other solid components of the mud cake.

Multi-component fibers useful as lost-circulation materials in the methods disclosed herein can have a variety of cross-sectional shapes. Useful fibers include those having at least one cross-sectional shape selected from the group consisting of circular, prismatic, cylindrical, lobed, rectangular, polygonal, or dog-boned. The fibers may be hollow or not hollow, and they may be straight or have an undulating shape. Differences in cross-sectional shape allow for control of active surface area, mechanical properties, and interaction with hollow ceramic microspheres or other components. In some embodiments, the fiber useful for practicing the present disclosure has a circular cross-section or a rectangular cross-section. Fibers having a generally rectangular cross-section shape are also typically known as ribbons. Fibers are useful, for example, because they provide large surface areas relative the volume they displace.

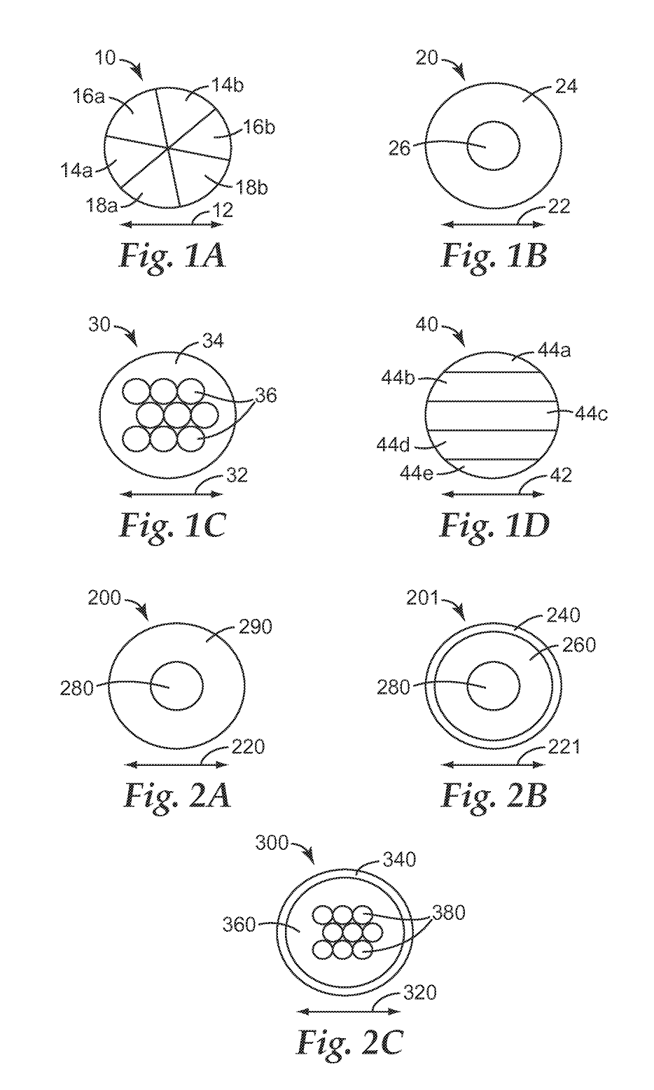

Examples of multi-component fibers useful for practicing the present disclosure include those with cross-sections illustrated in FIGS. 1A-1D. A core-sheath configuration, as shown in FIG. 1B or 1C, may be useful, for example, because of the large surface area of the sheath. In these configurations, the external surface of the fiber is typically made from a single polymeric composition. It is within the scope of the present disclosure for the core-sheath configurations to have multiple sheaths. Other configurations, for example, as shown in FIGS. 1A and 1D provide options that can be selected depending on the intended application. In the segmented pie wedge (see, e.g., FIG. 1A) and the layered (see, e.g., FIG. 1D) configurations, typically the external surface is made from more than one composition.

Referring to FIG. 1A, a pie-wedge fiber 10 has a circular cross-section 12, a first polymeric composition located in regions 16a and 16b, and a second polymeric composition located in regions 14a and 14b. Other regions in the fiber (18a and 18b) may include a third component (e.g., a third, different polymeric composition having a melting point of at least 140° C.) or may independently include the first polymeric composition or the second polymeric composition.

In FIG. 1B, fiber 20 has circular cross-section 22, sheath 24 of a first polymeric composition, and core 26 of a second polymeric composition. FIG. 1C shows fiber 30 having a circular cross-section 32 and a core-sheath structure with sheath 34 of a first polymeric composition and plurality of cores 36 of a second polymeric composition.

FIG. 1D shows fiber 40 having circular cross-section 42, with five layered regions 44a, 44b, 44c, 44d, 44e, which comprise alternatively at least the first polymeric composition and the second polymeric composition. Optionally, a third, different polymeric composition may be included in at least one of the layers.

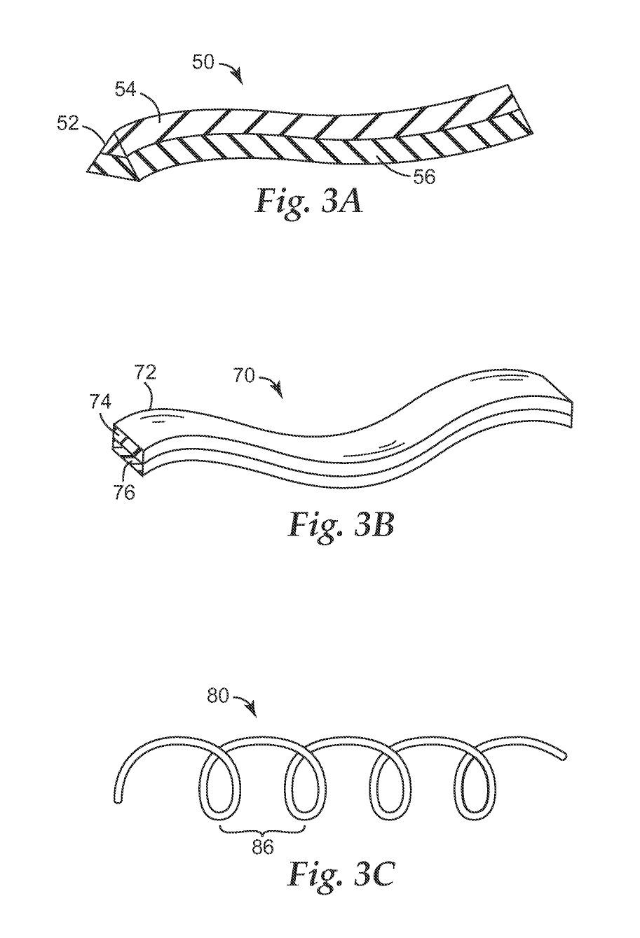

Other embodiments of fibers described herein include those illustrated in FIGS. 2A, 2B, and 2C. Referring to FIG. 2A, fiber 200 has circular cross-section 220, sheath 290 of the first polymeric composition that includes a curable resin, and core 280 of the second polymeric composition.

FIG. 2B shows fiber 201 having a circular cross-section 221, core 280 of the second polymeric composition, sheath 260 of the first polymeric composition, and second sheath 240 of a curable resin, surrounding the first polymeric composition in sheath 260.

FIG. 2C shows fiber 300 having a core-sheath structure with a circular cross-section 320, a sheath 360 of the first polymeric composition, a second sheath 340 of curable resin, and multiple cores 380 of the second thermoplastic composition.

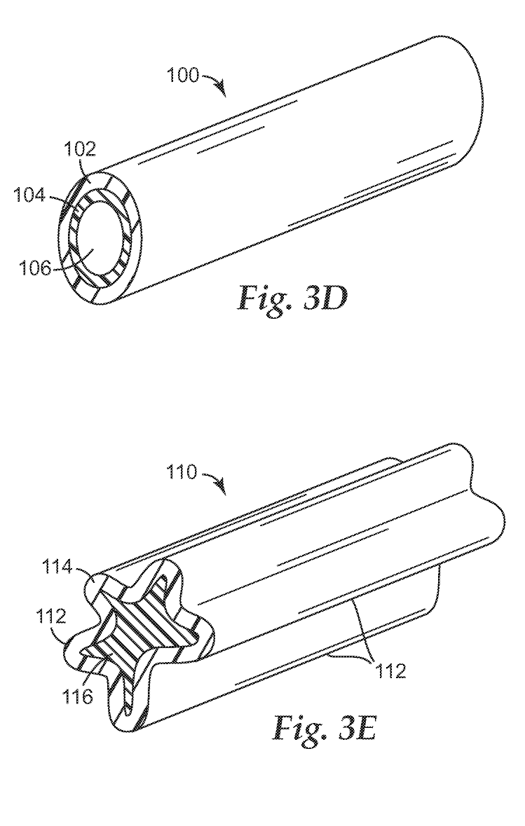

FIGS. 3A-3E illustrate perspective views of various embodiments of multi-component fibers useful for practicing the present disclosure. FIG. 3A illustrates a fiber 50 having a triangular cross-section 52. In the illustrated embodiment, the first polymeric composition 54 exists in one region, and the second polymeric composition 56 is positioned adjacent the first polymeric composition 54.

FIG. 3B illustrates a ribbon-shaped embodiment 70 having a generally rectangular cross-section and an undulating shape 72. In the illustrated embodiment, a first layer 74 comprises the first polymeric composition, while a second layer 76 comprises the second polymeric composition.

FIG. 3C illustrates a coiled or crimped multi-component fiber 80 useful for articles according to the present disclosure. The distance between coils, 86, may be adjusted according to the properties desired.

FIG. 3D illustrates a fiber 100 having a cylindrical shape, and having a first annular component 102, a second annular component 104, the latter component defining hollow core 106. The first and second annular components typically comprise the first polymeric composition and the second polymeric composition, respectively. The hollow core 106 may optionally be partially or fully filled with an additive (e.g., a curing agent or tackifier) for one of the annular components 102, 104.

FIG. 3E illustrates a fiber with a lobed-structure 110, the example shown having five lobes 112 with outer portions 114 and an interior portion 116. The outer portions 114 and interior portion 116 typically comprise the first polymeric composition and the second polymeric composition, respectively. The aspect ratio of multi-component fibers useful as lost-circulation materials in the methods disclosed herein may be, for example, at least 3:1, 4:1, 5:1, 10:1, 25:1, 50:1, 75:1, 100:1, 150:1, 200:1, 250:1, 500:1, 1000:1, or more; or in a range from 2:1 to 1000:1. Larger aspect ratios (e.g., having aspect ratios of 10:1 or more) may more easily allow the formation of a network of multi-component fibers and may allow for more particles in the mud cake to be adhered to the external surfaces of the fibers.

Multi-component fibers useful as lost-circulation materials in the methods according to the present disclosure include those having a length up to 60 millimeters (mm), in some embodiments, in a range from 2 mm to 60 mm, 3 mm to 40 mm, 2 mm to 30 mm, or 3 mm to 20 mm. Typically, the multi-component fibers disclosed herein have a maximum cross-sectional dimension up to 100 (in some embodiments, up to 90, 80, 70, 60, 50, 40, or 30) micrometers. For example, the fiber may have a circular cross-section with an average diameter in a range from 1 micrometer to 100 micrometers, 1 micrometer to 60 micrometers, 10 micrometers to 50 micrometers, 10 micrometers to 30 micrometers, or 17 micrometers to 23 micrometers. In another example, the fibers may have a rectangular cross-section with an average length (i.e., longer cross-sectional dimension) in a range from 1 micrometer to 100 micrometers, 1 micrometer to 60 micrometers, 10 micrometers to 50 micrometers, 10 micrometers to 30 micrometers, or 17 micrometers to 23 micrometers.

Typically, the dimensions of the multi-component fibers used together in the method according to the present disclosure, and components making up the fibers are generally about the same, although use of fibers with even significant differences in compositions and/or dimensions may also be useful. In some applications, it may be desirable to use two or more different types of multi-component fibers (e.g., at least one different polymer or resin, one or more additional polymers, different average lengths, or otherwise distinguishable constructions), where one group offers a certain advantage(s) in one aspect, and other group a certain advantage(s) in another aspect.

Optionally, fibers described herein may further comprise other components (e.g., additives and/or coatings) to impart desirable properties such as handling, processability, stability, and dispersability. Exemplary additives and coating materials include antioxidants, colorants (e.g., dyes and pigments), fillers (e.g., carbon black, clays, and silica), and surface applied materials (e.g., waxes, surfactants, polymeric dispersing agents, talcs, erucamide, gums, and flow control agents) to improve handling

Surfactants can be used to improve the dispersibility or handling of multi-component fibers described herein. Useful surfactants (also known as emulsifiers) include anionic, cationic, amphoteric, and nonionic surfactants. Useful anionic surfactants include alkylarylether sulfates and sulfonates, alkylarylpolyether sulfates and sulfonates (e.g., alkylarylpoly(ethylene oxide) sulfates and sulfonates, in some embodiments, those having up to about 4 ethyleneoxy repeat units, including sodium alkylaryl polyether sulfonates such as those known under the trade designation “TRITON X200”, available from Rohm and Haas, Philadelphia, Pa.), alkyl sulfates and sulfonates (e.g., sodium lauryl sulfate, ammonium lauryl sulfate, triethanolamine lauryl sulfate, and sodium hexadecyl sulfate), alkylaryl sulfates and sulfonates (e.g., sodium dodecylbenzene sulfate and sodium dodecylbenzene sulfonate), alkyl ether sulfates and sulfonates (e.g., ammonium lauryl ether sulfate), and alkylpolyether sulfate and sulfonates (e.g., alkyl poly(ethylene oxide) sulfates and sulfonates, in some embodiments, those having up to about 4 ethyleneoxy units). Useful nonionic surfactants include ethoxylated oleoyl alcohol and polyoxyethylene octylphenyl ether. Useful cationic surfactants include mixtures of alkyl dimethylbenzyl ammonium chlorides, wherein the alkyl chain has from 10 to 18 carbon atoms. Amphoteric surfactants are also useful and include sulfobetaines, N-alkylaminopropionic acids, and N-alkylbetaines. Surfactants may be added to the fibers disclosed herein, for example, in an amount sufficient on average to make a monolayer coating over the surfaces of the fibers to induce spontaneous wetting. Useful amounts of surfactants may be in a range, for example, from 0.05 to 3 percent by weight, based on the total weight of the multi-component fiber.

Polymeric dispersing agents may also be used, for example, to promote the dispersion of fibers described herein in a chosen fluid, and at the desired application conditions (e.g., pH and temperature). Exemplary polymeric dispersing agents include salts (e g, ammonium, sodium, lithium, and potassium) of polyacrylic acids of greater than 5000 average molecular weight, carboxy modified polyacrylamides (available, for example, under the trade designation “CYANAMER A-370” from Cytec Industries, West Paterson, N.J.), copolymers of acrylic acid and dimethylaminoethylmethacrylate, polymeric quaternary amines (e.g., a quaternized polyvinyl-pyrollidone copolymer (available, for example, under the trade designation “GAFQUAT 755” from ISP Corp., Wayne, N.J.) and a quaternized amine substituted cellulosic (available, for example, under the trade designation “JR-400” from Dow Chemical Company), cellulosics, carboxy-modified cellulosics (e.g., sodium carboxy methycellulose (available, for example, under the trade designation “NATROSOL CMC Type 7L” from Hercules, Wilmington, Del.), and polyvinyl alcohols. Polymeric dispersing agents may be added to the fibers disclosed herein, for example, in an amount sufficient on average to make a monolayer coating over the surfaces of the fibers to induce spontaneous wetting. Useful amounts of polymeric dispersing agents may be in a range, for example, from 0.05 to 5 percent by weight, based on the total weight of the fiber.

Examples of antioxidants include hindered phenols (available, for example, under the trade designation “IRGANOX” from Ciba Specialty Chemical, Basel, Switzerland). Typically, antioxidants are used in a range from 0.1 to 1.5 percent by weight, based on the total weight of the fiber, to retain useful properties during extrusion.

In some embodiments, multi-component fibers useful as lost-circulation materials in the methods described herein may be crosslinked, for example, through radiation or chemical means. That is, at least one of the first polymeric composition or second polymeric composition may be crosslinked before the fibers are dispersed in a fluid and used while drilling the well. Chemical crosslinking can be carried out, for example, by incorporation of thermal free radical initiators, photoinitiators, or ionic crosslinkers. When exposed to a suitable wavelength of light, for example, a photoinitiator can generate free radicals that cause crosslinking of polymer chains. With radiation crosslinking, initiators and other chemical crosslinking agents may not be necessary. Suitable types of radiation include any radiation that can cause crosslinking of polymer chains such as actinic and particle radiation (e.g., ultraviolet light, X rays, gamma radiation, ion beam, electronic beam, or other high-energy electromagnetic radiation). Crosslinking may be carried out to a level at which, for example, an increase in modulus of the first polymeric composition is observed. At least one of hydrolytic or hydrocarbon resistance may be improved by such crosslinking.

Multi-component fibers useful as lost-circulation materials in the methods disclosed herein may be added to a drilling fluid or a pill treatment composition in any useful amount. For example, the multi-component fibers may be present in the drilling fluid in a range from 0.01 percent by weight to 2 percent by weight, based on the total weight of the drilling fluid.

In some embodiments, the lost-circulation materials useful in the methods disclosed herein include other fibers, different from the multi-component fibers. In some embodiments, the other fibers comprise at least one of metallic fibers, glass fibers, carbon fibers, mineral fibers, or ceramic fibers. In some embodiments, the other fibers are made from any of the materials described above for the second polymeric composition or polyvinyl alcohol, rayon, acrylic, aramid, or phenolics. Other useful materials for the other fibers include natural fibers such as wool, silk, cotton, or cellulose. The other fibers can help form a three-dimensional network or mesh by adhering to the multi-component fibers. The three-dimensional network can block particles and form a strong, impermeable mud cake. Using other fibers in combination with the multi-component fibers may lower the cost of the drilling fluid or pill treatment composition, depending on the type of other fiber used. A range of weight ratios of multi-component fibers to the other fibers may be useful. For example, a weight ratio of multi-component fibers to other, different fibers may be in a range from 10:1 to 1:5.

In some embodiments, the lost-circulation materials useful in the methods disclosed herein include particles. However, as shown in the Examples, below, multi-component fibers may be useful as lost-circulation materials even in the absence of added particles, beyond the particles that are present in the drill cuttings. In some embodiments, the particles comprise at least one of silica (e.g., sand), mica, calcium carbonate (including finely ground limestone and spun limestone), magnesium carbonate, and rock wool. Particle size may be selected based on the type of formation being drilled. A mud cake typically can form when the drilling fluid contains particles that are approximately the same size as or have diameters greater than about one third of the pore diameter (or the width of any openings such as induced fractures) in the formation being drilled. Other examples of useful particles include poly-paraphenyleneterephthalamide, rubber, polyethylene, polypropylene, polystyrene, acrylonitrile butadiene, pre-crosslinked substituted vinyl acrylate copolymers, polyaramid, poly(methyl methacrylate), poly(styrene-butadiene), fly ash, alumina, glass, iron carbonate, dolomite, marble, barite, graphite, ceramic, metals and metal oxides, melamine resins, starch and modified starch, hematite, ilmenite, microspheres, glass microspheres, magnesium oxide, gilsonite, and sand. Oil-swellable particles may also be useful, such as those described in U.S. Pat. App. Pub. No. 2010/0298175 (Ghassemzadeh). In some embodiments, the lost-circulation materials useful in the methods disclosed herein include benzoic acid flakes.

The multi-component fibers and optionally other fibers and particles may be combined with the drilling fluid or pill treatment fluid, including any of those described above, in any order and with any suitable equipment to form the drilling mud or pill treatment. The multi-component fibers may be added as discrete fibers, and they may also be added as an aggregate of fibers, as described in U.S. Pat. App. Pub. No. 2010/0288500 (Carlson et al.). The multi-component fibers and the fluid and optionally other fibers or particles are typically combined before pumping downhole. However, it is also possible that the multi-component fibers and optionally other fibers or particles may be added while pumping on the fly, for example, with special shakers. A weighting material may optionally be added to the fluid, the multi-component fibers, or the other fibers and particles at any point. Typically, the treatment fluid and the spacers are weighted to approximately the same density as the drilling mud to minimize migration of the treatment fluid and mixing with the drilling mud. The treatment fluid may be added in a discrete amount, for example as a pill, or may be added until lost circulation is satisfactorily reduced. In some embodiments, the treatment fluid is spotted adjacent to the location of the lost circulation, if known, by methods known in the art.

In some embodiments of the method of reducing lost circulation disclosed herein, when the method is a “pill” treatment, the pill can be injected into the well after a first spacer, before a second spacer, or both. The first spacer ahead of the pill may be useful for cleaning the surface of the wellbore and therefore may contain a surfactant (e.g., a non-ionic surfactant such as a fatty acid diethanolamide, an alkyl benzenesulfonic acid salt, and an ethoxylated or propoxylated short chain alcohol). A clean surface may provide a better foundation for a mud cake adhered together by the multi-component fibers to form. A first spacer can be useful for changing the wettability of the formation surface, for example, when an oil-based drilling fluid is used and an aqueous pill treatment is desirable. Both the first and second spacers may be useful as barriers to prevent interaction between the drilling fluid and the pill or to prevent contamination of the pill by the drilling mud. The spacers may, in some embodiments, include additives such as anti-foam agents (e.g., siloxanes, silicones and long chain hydroxy compounds such as glycols), viscosifiers such as polymers and viscoelastic surfactants, fluid loss additives, weighting agents (e.g., barium sulfate, calcium carbonate or hematite), and extenders such as bentonite and sodium silicates.

Methods according to the present disclosure can be carried out with standard drilling tools, such as hydraulically operated drill bits or rotary drill bits. The methods disclosed herein can be used to drill vertical wells, deviated wells, inclined wells or horizontal wells and may be useful for oil wells, gas wells, and combinations thereof. The subterranean formations that may be drilled include siliciclastic (e.g., shale, conglomerate, diatomite, sand, and sandstone) or carbonate (e.g., limestone) formations.

The first polymeric composition and the multi-component fibers that contain the first polymeric composition advantageously can adhere the mud cake or plug to the subterranean formation. Therefore, in some embodiments, the first polymeric composition may be selected, for example, to have good adhesion to the formation being drilled.

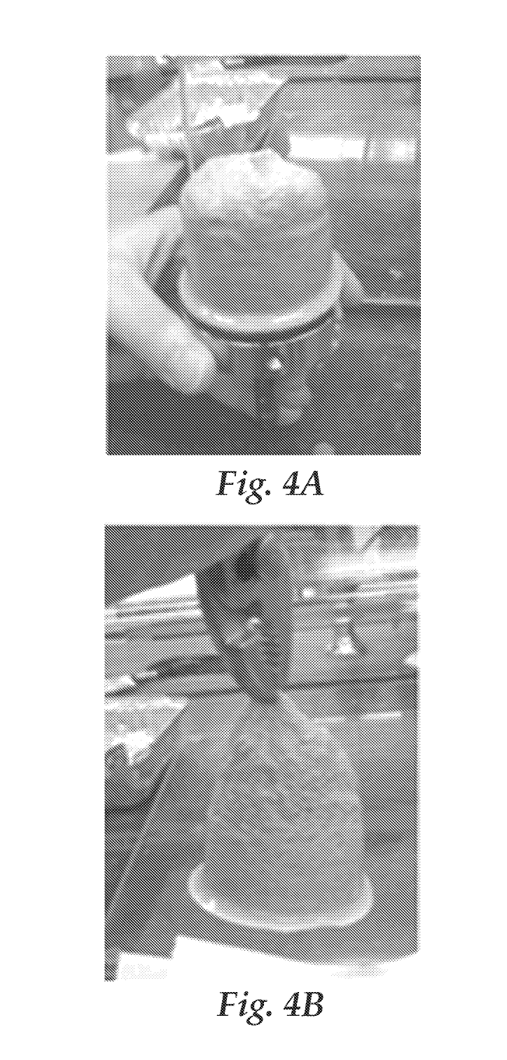

Photographs of Mud Cake 2, described in the Examples, below, are shown in FIGS. 4A and 4B. Mud Cake 2 was prepared using multi-component fibers described herein. The photographs show how the multi-component fibers adhere to each other and the other solid components in the mud cake to form a mud cake with cohesive integrity, even when being held and suspended with pliers, as shown in FIG. 4B. Furthermore, FIG. 4B illustrates that the multi-component fibers can provide unexpectedly thick and self-bonded filter cakes, which may be advantageous in some embodiments when plugging larger openings such as natural fractures, caverns, or vugs that are encountered during drilling.

### Some Embodiments of the Disclosure

In a first embodiment, the present disclosure provides a method of forming a subterranean well, the method comprising:

drilling the subterranean well with a drilling mud comprising lost-circulation material; and

forming a mud cake comprising drill cuttings and the lost-circulation material,

wherein the lost-circulation material comprises multi-component fibers having external surfaces and comprising at least a first polymeric composition and a second polymeric composition, wherein at least a portion of the external surfaces of the multi-component fibers comprises the first polymeric composition, and wherein the first polymeric composition at least partially adhesively bonds the mud cake.

In a second embodiment, the present disclosure provides the method of the first embodiment, wherein the drilling mud comprises an oil-based drilling fluid comprising at least one of crude oil, diesel oil, biodiesel oil, kerosene, mineral oil, gasoline, naphtha, or toluene.

In a third embodiment, the present disclosure provides the method of the first embodiment, wherein the drilling mud comprises an aqueous drilling fluid.

In a fourth embodiment, the present disclosure provides a method of reducing lost circulation in a subterranean well while drilling the subterranean well, the method comprising:

injecting a composition comprising lost-circulation material into the subterranean well through a drill pipe;

forming a mud cake comprising the lost-circulation material; and

resuming drilling of the subterranean well after injecting the lost-circulation material;

wherein the lost-circulation material comprises multi-component fibers having external surfaces and comprising at least a first polymeric composition and a second polymeric composition, wherein at least a portion of the external surfaces of the multi-component fibers comprises the first polymeric composition, and wherein the first polymeric composition at least partially adhesively bonds the mud cake.

In a fifth embodiment, the present disclosure provides the method of the fourth embodiment, wherein the composition is an oil-based composition comprising at least one of crude oil, diesel oil, biodiesel oil, kerosene, mineral oil, gasoline, naphtha, or toluene.

In a sixth embodiment, the present disclosure provides the method of the fourth embodiment, wherein the composition is aqueous.

In a seventh embodiment, the present disclosure provides the method of any one of the fourth to sixth embodiments, further comprising at least one of injecting a first spacer into the subterranean well before injecting the lost-circulation material into the subterranean well or injecting a second spacer into the subterranean well after injecting the lost-circulation material into the subterranean well and before resuming drilling.

In an eighth embodiment, the present disclosure provides the method of any one of the first to seventh embodiments, wherein the multi-component fibers are non-fusing at a temperature encountered in the well, for example, at a temperature of at least 110° C.

In a ninth embodiment, the present disclosure provides the method of any one of the first to eighth embodiments, wherein the second polymeric composition has a melting point higher than a temperature encountered in the well.

In a tenth embodiment, the present disclosure provides the method of any one of the first to ninth embodiments, wherein the second polymeric composition comprises at least one of an ethylene-vinyl alcohol copolymer, a polyamide, a polyoxymethylene, a polypropylene, a polyester, a polyurethane, a polysulfone, a polyimide, a polyetheretherketone, or a polycarbonate, for example, a polyamide.

In an eleventh embodiment, the present disclosure provides the method of any one of the first to tenth embodiments, wherein the first polymeric composition has a softening temperature of up to 150° C., wherein the second polymeric composition has a melting point of at least 130° C., and wherein the difference between the softening temperature of the first polymeric composition and the melting point of the second polymeric composition is at least 10° C.

In a twelfth embodiment, the present disclosure provides the method of any one of the first to eleventh embodiments, wherein the first polymeric composition has an elastic modulus of less than 3×10⁵ N/m² at a temperature of at least 80° C. measured at a frequency of one hertz.

In a thirteenth embodiment, the present disclosure provides the method of any one of the first to twelfth embodiments, wherein the first polymeric composition comprises at least one of an ethylene-vinyl alcohol copolymer, an at least partially neutralized ethylene-methacrylic acid or ethylene-acrylic acid copolymer, a polyurethane, a polyoxymethylene, a polypropylene, a polyolefin, an ethylene-vinyl acetate copolymer, a polyester, a polyamide, a phenoxy polymer, a vinyl polymer, or an acrylic polymer, for example, an at least partially neutralized ethylene-methacrylic acid or ethylene-acrylic acid copolymer.

In a fourteenth embodiment, the present disclosure provides the method of any one of the first to thirteenth embodiments, wherein the multi-component fiber further comprises a curable resin.

In a fifteenth embodiment, the present disclosure provides the method of the fourteenth embodiment, wherein the curable resin comprises at least one of an epoxy, phenolic, acrylic, isocyanate, phenoxy, vinyl, vinyl ether, or silane.

In a sixteenth embodiment, the present disclosure provides the method of any one of the first to fifteenth embodiments, wherein the multi-component fibers are in a range from 3 millimeters to 60 millimeters in length.

In a seventeenth embodiment, the present disclosure provides the method of any one of the first to sixteenth embodiments, wherein the multi-component fibers are in a range from 10 to 100 micrometers in diameter.

In an eighteenth embodiment, the present disclosure provides the method of any one of the first to seventeenth embodiments, wherein the lost-circulation material comprises at least two different types of the multi-component fibers.

In a nineteenth embodiment, the present disclosure provides the method of any one of the first to eighteenth embodiments, wherein the lost-circulation material further comprises other fibers, different from the multi-component fibers.

In a twentieth embodiment, the present disclosure provides the method of the nineteenth embodiment, wherein the other fibers comprise at least one of metallic fibers, glass fibers, carbon fibers, mineral fibers, or ceramic fibers.

In a twenty-first embodiment, the present disclosure provides the method of any one of the first to twentieth embodiments, wherein the lost-circulation material further comprises particles.

In a twenty-second embodiment, the present disclosure provides the method of the twenty-first embodiment, wherein the particles comprise at least one of sand, mica, calcium carbonate, magnesium carbonate, and rock wool.

In a twenty-third embodiment, the present disclosure provides the use of multi-component fibers as a lost-circulation material during the drilling of a subterranean well, the multi-component fibers having external surfaces and comprising at least a first polymeric composition and a second polymeric composition, wherein at least a portion of the external surfaces of the multi-component fibers comprises the first polymeric composition, and wherein the first polymeric composition at least partially adhesively bonds a mud cake formed during the drilling.

In a twenty-fourth embodiment, the present disclosure provides the use of the twenty-third embodiment, wherein the multi-component fibers are circulated in a drilling mud.

In a twenty-fifth embodiment, the present disclosure provides the use of the twenty-fourth embodiment, wherein the drilling mud comprises an oil-based drilling fluid comprising at least one of crude oil, diesel oil, biodiesel oil, kerosene, mineral oil, gasoline, naphtha, or toluene.

In a twenty-sixth embodiment, the present disclosure provides the use of the twenty-fourth embodiment, wherein the drilling mud comprises an aqueous drilling fluid.

In a twenty-seventh embodiment, the present disclosure provides the use of any one of the twenty-fourth to twenty-sixth embodiments, wherein the multi-component fibers are used in a pill treatment.

In a twenty-eighth embodiment, the present disclosure provides the use of the twenty-seventh embodiment, wherein the pill treatment comprises an oil-based fluid comprising at least one of crude oil, diesel oil, biodiesel oil, kerosene, mineral oil, gasoline, naphtha, or toluene.

In a twenty-ninth embodiment, the present disclosure provides the use of the twenty-seventh embodiment, wherein the pill treatment comprises water.

In a thirtieth embodiment, the present disclosure provides the use of any one of the twenty-third to twenty-ninth embodiments, wherein the multi-component fibers are non-fusing at a temperature encountered in the well, for example, at a temperature of at least 110° C.

In a thirty-first embodiment, the present disclosure provides the use of any one of the twenty-third to thirtieth embodiments, wherein the second polymeric composition is at least one of an ethylene-vinyl alcohol copolymer, polyamide, polyoxymethylene, polypropylene, polyester, polyurethane, polysulfone, polyimide, polyetheretherketone, or polycarbonate, for example, polyamide.

In an thirty-second embodiment, the present disclosure provides the use of any one of the twenty-third to thirty-first embodiments, wherein the first polymeric composition has a softening temperature of up to 150° C., wherein the second polymeric composition has a melting point of at least 130° C., and wherein the difference between the softening temperature of the first polymeric composition and the melting point of the second polymeric composition is at least 10° C.

In a thirty-third embodiment, the present disclosure provides the use of any one of the twenty-third to thirty-second embodiments, wherein the first polymeric composition has an elastic modulus of less than 3×10⁵ N/m² at a temperature of at least 80° C. measured at a frequency of one hertz.

In a thirty-fourth embodiment, the present disclosure provides the use of any one of the twenty-third to thirty-third embodiments, wherein the first polymeric composition comprises at least one of an ethylene-vinyl alcohol copolymer, an at least partially neutralized ethylene-methacrylic acid or ethylene-acrylic acid copolymer, a polyurethane, a polyoxymethylene, a polypropylene, a polyolefin, an ethylene-vinyl acetate copolymer, a polyester, a polyamide, a phenoxy polymer, a vinyl polymer, or an acrylic polymer.

In a thirty-fifth embodiment, the present disclosure provides the use of any one of the twenty-third to thirty-fourth embodiments, wherein the multi-component fiber further comprises a curable resin.

In a thirty-sixth embodiment, the present disclosure provides the use of the thirty-fifth embodiment, wherein the curable resin comprises at least one of an epoxy, phenolic, acrylic, isocyanate, phenoxy, vinyl, vinyl ether, or silane.

In a thirty-seventh embodiment, the present disclosure provides the use of any one of the twenty-third to thirty-sixth embodiments, wherein the multi-component fibers are in a range from 3 millimeters to 60 millimeters in length, and wherein the multi-component fibers are in a range from 10 to 100 micrometers in diameter.

In a thirty-eighth embodiment, the present disclosure provides the use of any one of the twenty-third to thirty-seventh embodiments, wherein at least two different types of the multi-component fibers are used together.

In a thirty-ninth embodiment, the present disclosure provides the use of any one of the twenty-third to thirty-eighth embodiments, wherein the multi-component fibers are used in combination with other fibers, different from the multi-component fibers.

In a fortieth embodiment, the present disclosure provides the use of the thirty-ninth embodiment,

wherein the other fibers comprise at least one of metallic fibers, glass fibers, carbon fibers, mineral fibers, or ceramic fibers.

In a forty-first embodiment, the present disclosure provides the use of any one of the twenty-third to fortieth embodiments, wherein the multi-component fibers are used in combination with particles.

In a forty-second embodiment, the present disclosure provides the use of the forty-first embodiment, wherein the particles comprise at least one of sand, mica, calcium carbonate, magnesium carbonate, and rock wool.

In a forty-third embodiment, the present disclosure provides the use of any one of the twenty-third to forty-second embodiments, wherein the second polymeric composition has a melting point higher than a temperature encountered in the well.

In a forty-fourth embodiment, the present disclosure provides the use of any one of the twenty-third to forty-third embodiments, further comprising at least one of injecting a first spacer into the subterranean well before injecting the lost-circulation material into the subterranean well or injecting a second spacer into the subterranean well after injecting the lost-circulation material into the subterranean well and before resuming drilling.

In order that this disclosure can be more fully understood, the following examples are set forth. The particular materials and amounts thereof recited in these examples, as well as other conditions and details, should not be construed to unduly limit this disclosure.

### EXAMPLES

### Comparative Drilling Mud A

A 10% potassium chloride drilling mud was prepared following the procedure outlined in “API Recommended Practice 13I” (Seventh Edition, February 2004). In a container, 11 grams (g) of potassium chloride granules (obtained under the trade designation “Potassium Chloride, Granular AR (ACS)”, from Mallinckrodt Chemicals, Phillipsburg, N.J.) were dissolved in 1L of de-ionized water. About 1 g of xanthan gum (obtained under the trade designation “VANZAN”, from R.T. Vanderbilt Company, Inc., Norwalk, Conn.) was slowly added to 360 g of the potassium chloride solution, while stirring, using a high shear mixer (commercially available under the trade designation “DISPERMAT”, from VMA-Getzmann GMBH, Reichshof, Germany). After 5 minutes, the container was removed from the mixer and the sides were scraped to dislodge any adhered material. Stirring was resumed and continued for an additional 10 minutes. About 30 g of simulated drilled solids (obtained under the trade designation “REV DUST” from Diversity Technologies Corp., Alberta, Canada) were added to the mixture while continuing to stir. After about 5 minutes, the container was removed from the mixer to dislodge any adhered material and then replaced on the mixer for an additional mixing time of 10 minutes.

### Drilling Muds 1 and 2

Drilling muds were prepared as described in Comparative Drilling Mud A, except that multi-component fibers were also added to the mixture. Multi-component fibers were prepared as generally described in Example 4 of PCT Publication No. WO 2009/079310, the disclosure of which is incorporated herein by reference, except that “AMPLIFY 10 3702” ethylene acrylic acid ionomer (obtained from Dow Chemical, Midland, Mich.) was used as the sheath material, and “ULTRAMID B24” polyamide 6 (obtained from BASF North America, Florham Park, N.J.) was used as the core material. The fibers were cut to a length of about 0.25 in (0.63 cm), added to the drilling muds, and mixed using a constant speed mixer (model “3060” obtained from Chandler Engineering, Tulsa, Okla.) at 4000 rpm for about 50 seconds. For Drilling Muds 1 and 2, respectively, 0.1 and 0.5 weight % of fibers were added.

The softening temperature of “AMPLIFY IO 3702” ethylene acrylic acid ionomer was found to be 110° C. when evaluated using the method described in the Detailed Description (page 5, line 33 to page 6, line 10). That is, the crossover temperature was 110° C. Also using this method except using a frequency of 1.59 Hz, the elastic modulus was found to be 8.6×10⁴ N/m² at 100° C., 6.1×10⁴N/m² at 110° C., 4.3×10⁴ N/m² at 120° C., 2.8×10⁴ N/m² at 130° C., 1.9×10⁴ N/m² at 140° C., 1.2×10⁴N/m² at 150° C., and 7.6×10³ N/m² at 160° C. The melting point of “AMPLIFY IO 3702” ethylene acrylic acid ionomer is reported to be 92.2° C. by Dow Chemical in a data sheet dated 2011. The melting point of “ULTRAMID B24” polyamide 6 is reported to be 220° C. by BASF in a product data sheet dated September 2008. The grade of the “ULTRAMID B24” polyamide 6 did not contain titanium dioxide.

### Drilling Mud 3

A drilling mud was prepared as described in Drilling Muds 1 and 2, except that polyethylene terephthalate (PET) fibers (obtained under the trade designation “VPB 105-2” from Engineered Fibers Technology, Shelton, Conn.) about 0.40 cm long were also added to the mixture at a weight ratio of 2:1 multi-component fibers/PET fibers for a total fiber content of 0.5 wt %.

### Drilling Mud 4

A drilling mud was prepared as described in Drilling Mud 3, except that PET fibers (obtained under the trade designation “VPB 105-2” from Engineered Fibers Technology) were added to the mixture at a weight ratio of 1:2 multi-component fibers/PET fibers.

### Comparative Drilling Mud B

Comparative Drilling Mud B was prepared as described in Drilling Muds 1 and 2, except that no multi-component fibers were used, and about 0.5 wt % of PET fibers (obtained under the trade designation “VPB 105-2” from Engineered Fibers Technology) were used instead.

### Comparative Mud Cakes A and B and Mud Cakes 1 to 4

Comparative Drilling Muds A and B and Drilling Muds 1 to 4 were used to prepare, respectively, Comparative Mud Cakes A and B and Mud Cakes 1 to 3, using a high pressure-high temperature (HPHT) filter press (Part No. 171-00 Series from OFI Testing Equipment, Houston Tex.), at a pressure of about 500 psi (3.45×10⁶ Pascals). Filter paper (Catalog No. 170-19 from OFI Testing Equipment) was used as filter medium and the temperature was gradually increased from about room temperature to about 265° F. (130° C.) in approximately 30 minutes, after which, filtrate volume was collected and measured. Results are reported in Table 1, below. Average thickness of Comparative Mud Cakes A and B and Mud Cakes 1 to 4 was also measured and is reported in Table 1, below.

TABLE 1

| Examples | Filtrate (mL) | Thickness (in) [cm] |
|---|---|---|
| Comparative Mud Cake A | 72 | 0.25 [0.63] |
| Comparative Mud Cake B | 20 | 0.0625 [0.16] |
| Mud Cake 1 | 40 | 0.50 [1.27] |
| Mud Cake 2 | 35 | 1.75 [4.45] |
| Mud Cake 3 | 25 | 2.00 [5.08] |
| Mud Cake 4 | 24 | 1.00 [2.54] |

Comparative Mud Cakes A and B and Mud Cakes 1 to 4 were also inspected for overall appearance and apparent cohesion strength. While Mud Cakes 1 to 4 maintained their integrity when held and suspended by pliers, Comparative Mud Cakes A and B showed cohesion failure when subjected to the same qualitative test. Photographs of the Mud Cake 2 are shown in FIGS. 4A and 4B. The photograph of FIG. 4B shows that Mud Cake 2 maintained its integrity when held and suspended by pliers.

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

What is claimed is:

1. A method of forming a subterranean well, the method comprising:
drilling the subterranean well with a drilling mud comprising lost-circulation material; and
forming a mud cake comprising drill cuttings and the lost-circulation material, wherein the lost-circulation material comprises multi-component fibers having external surfaces and comprising at least a first polymeric composition and a second polymeric composition, wherein at least a portion of the external surfaces of the multi-component fibers comprises the first polymeric composition, and wherein the first polymeric composition at least partially adhesively bonds the mud cake.

2. The method of claim 1, wherein the drilling mud comprises an oil-based drilling fluid comprising at least one of crude oil, diesel oil, biodiesel oil, kerosene, mineral oil, gasoline, naphtha, or toluene.

3. The method of claim 1, wherein the drilling mud comprises an aqueous drilling fluid.

4. The method of claim 1, wherein the multi-component fibers are non-fusing at a temperature encountered in the well.

5. The method of claim 1, wherein the second polymeric composition has a melting point higher than a temperature encountered in the well.

6. The method of claim 1, wherein the second polymeric composition comprises at least one of an ethylene-vinyl alcohol copolymer, a polyamide, a polyoxymethylene, a polypropylene, a polyester, a polyurethane, a polysulfone, a polyimide, a polyetheretherketone, or a polycarbonate.

7. The method of claim 1, wherein the first polymeric composition has an elastic modulus of less than 3×10⁵ N/m² at a temperature of at least 80° C. measured at a frequency of one hertz.

8. The method of claim 1, wherein the first polymeric composition comprises at least one of ethylene-vinyl alcohol copolymer, at least partially neutralized ethylene-methacrylic acid or ethylene-acrylic acid copolymer, polyurethane, polyoxymethylene, polypropylene, polyolefin, ethylene-vinyl acetate copolymer, polyester, polyamide, phenoxy, vinyl, or acrylic.

9. The method of claim 1, wherein the first polymeric composition has a softening temperature of up to 150° C., wherein the second polymeric composition has a melting point of at least 130° C., and wherein the difference between the softening temperature of the first polymeric composition and the melting point of the second polymeric composition is at least 10° C.

10. The method of claim 1, wherein the multi-component fiber further comprises a curable resin.

11. The method of claim 1, wherein the lost-circulation material further comprises at least one of other fibers, different from the multi-component fibers, or particles.

12. A method of reducing lost circulation in a subterranean well while drilling the subterranean well, the method comprising:
injecting a composition comprising lost-circulation material into the subterranean well through a drill pipe;
forming a mud cake comprising the lost-circulation material;
resuming drilling of the subterranean well after injecting the lost-circulation material, wherein the lost-circulation material comprises multi-component fibers having external surfaces and comprising at least a first polymeric composition and a second polymeric composition, wherein at least a portion of the external surfaces of the multi-component fibers comprises the first polymeric composition, and wherein the first polymeric composition at least partially adhesively bonds the mud cake.

13. The method of claim 12, further comprising at least one of injecting a first spacer into the subterranean well before injecting the lost-circulation material into the subterranean well or injecting a second spacer into the subterranean well after injecting the lost-circulation material into the subterranean well and before resuming drilling.

14. The method of claim 12, wherein the multi-component fibers are non-fusing at a temperature encountered in the well.

15. The method of claim 12, wherein the second polymeric composition has a melting point higher than a temperature encountered in the well.

16. The method of claim 12, wherein the second polymeric composition comprises at least one of an ethylene-vinyl alcohol copolymer, a polyamide, a polyoxymethylene, a polypropylene, a polyester, a polyurethane, a polysulfone, a polyimide, a polyetheretherketone, or a polycarbonate.

17. The method of claim 12, wherein the first polymeric composition has an elastic modulus of less than 3×10⁵ N/m² at a temperature of at least 80° C. measured at a frequency of one hertz.

18. The method of claim 12, wherein the first polymeric composition comprises at least one of ethylene-vinyl alcohol copolymer, at least partially neutralized ethylene-methacrylic acid or ethylene-acrylic acid copolymer, polyurethane, polyoxymethylene, polypropylene, polyolefin, ethylene-vinyl acetate copolymer, polyester, polyamide, phenoxy, vinyl, or acrylic.

19. The method of claim 12, wherein the first polymeric composition has a softening temperature of up to 150° C., wherein the second polymeric composition has a melting point of at least 130° C., and wherein the difference between the softening temperature of the first polymeric composition and the melting point of the second polymeric composition is at least 10° C.

20. The method of claim 12, wherein the lost-circulation material further comprises at least one of other fibers, different from the multi-component fibers, or particles.
